(19) United States
(12) Patent Application Publication
(10) Pub. No.: US 2026/0222658 A1
(43) Pub. Date: Jul. 30, 2026

(54) VIDEO TEMPLATE GENERATION METHOD AND APPARATUS, AND ELECTRONIC DEVICE

(71) Applicant: Beijing Zitiao Network Technology Co., Ltd., Haidian District, Beijing (CN)

(72) Inventors: Wozhou HE, Beijing (CN); Jingya YU, Beijing (CN); Qi CHEN, Beijing (CN)

(21) Appl. No.: 19/149,284

(22) PCT Filed: Dec. 8, 2023
(86) PCT No.: PCT/CN2023/137518

§ 371 Date: Jul. 18, 2025

(30) Foreign Application Priority Data
Jan. 20, 2023 (CN) 202310102385.1

(51) Int. Cl. H04N 21/81; H04N 21/44; H04N 21/854

(52) U.S. Cl. CPC H04N 21/816; H04N 21/44008; H04N 21/854

(57) ABSTRACT

Disclosed in the embodiments of the present application are a video template generation method and apparatus, and an electronic device. A specific embodiment of the method comprises: acquiring a video to be analyzed; on the basis of said video, performing transition detection to obtain target transition information; on the basis of said video, determining material information; and on the basis of the target transition information and the material information, generating a video template corresponding to said video.

The present application is based on and claims the priority to the Chinese application No. 202310102385.1 filed on Jan. 20, 2023, the disclosure of which is incorporated by reference herein in its entirety.

### TECHNICAL FIELD

Embodiments of the present disclosure relates to the field of computer technology, and specifically to a video template generation method and apparatus, and an electronic device.

### BACKGROUND

When viewing some interested videos on a terminal application, Internet users often have a wish of imitative creation of a same-type video.

### SUMMARY

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

In a first aspect, an embodiment of the present disclosure provides a video template generation method, comprising: acquiring a video to be analyzed; on the basis of the video to be analyzed, performing transition detection to obtain target transition information; on the basis of the video to be analyzed, determining material information; and on the basis of the target transition information and the material information, generating a video template corresponding to the video to be analyzed.

In a second aspect, an embodiment of the present disclosure provides a video template generation apparatus, comprising: an acquisition unit configured to acquire a video to be analyzed; a detection unit configured to, on the basis of the video to be analyzed, perform transition detection to obtain target transition information; a determination unit configured to, on the basis of the video to be analyzed, determine material information; and a generation unit configured to, on the basis of the target transition information and the material information, generate a video template corresponding to the video to be analyzed.

In a third aspect, an embodiment of the present disclosure provides an electronic device, comprising: one or more processors; and a storage device configured to store one or more programs which, when executed by the one or more processors, cause the one or more processors to implement the video template generation method according to the first aspect.

In a fourth aspect, an embodiment of the present disclosure provides a computer-readable medium having thereon stored a computer program which, when executed by a processor, implements the steps of the video template generation method according to the first aspect.

### BRIEF DESCRIPTION OF THE DRAWINGS

The above and other features, advantages, and aspects of the embodiments of the present disclosure will become more apparent by combining the accompanying drawings and referring to the following DETAILED DESCRIPTION. Throughout the drawings, the same or similar reference numbers refer to the same or similar elements. It should be understood that the drawings are schematic and that components and elements are not necessarily drawn to scale.

FIG. 1 is a flow diagram of a video template generation method according to one embodiment of the present disclosure;

FIG. 2 is a flow diagram of a video template generation method according to another embodiment of the present disclosure;

FIG. 3 is a schematic diagram of one application scenario for a video template generation method according to the present disclosure;

FIG. 4 is a flow diagram of a video template generation method according to yet another embodiment of the present disclosure;

FIG. 5 is a flow diagram of detecting a cut-away video frame in a video template generation method according to one embodiment of the present disclosure;

FIG. 6 is a flow diagram of recognizing a transition type in a video template generation method according to one embodiment of the present disclosure;

FIG. 7 is a schematic diagram of one application scenario for recognizing a transition type in a video template generation method according to the present disclosure;

FIG. 8 is a schematic diagram of one application scenario for detecting transition information in a video template generation method according to the present disclosure;

FIG. 9 is a schematic structural diagram of a video template generation apparatus according to one embodiment of the present disclosure;

FIG. 10 is an exemplary architecture diagram of a system to which various embodiments of the present disclosure may be applied;

FIG. 11 is a schematic structural diagram of a computer system of an electronic device suitable for implementing an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, rather these embodiments are provided for a more complete and thorough understanding of the present disclosure. It should be understood that the drawings and embodiments of the present disclosure are for exemplary purposes only and are not intended to limit the scope of protection of the present disclosure.

It should be understood that steps recited in method implementations of the present disclosure may be performed in a different order, and/or performed in parallel. Furthermore, the method implementations may include additional steps and/or omit performing the illustrated steps. The scope of the present disclosure is not limited in this respect.

The term “including” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that the modification of “a” or “a plurality” mentioned in the present disclosure is intended to be illustrative rather than restrictive, and that those skilled in the art should appreciate that it should be understood as “one or more” unless otherwise explicitly stated in the context.

Most of existing short video applications have provided a user with templates supporting same-type creation, but the templates all need jumping to other special editing applications for production, and cannot directly support creation of a same-type video for any video.

According to a video template generation method and apparatus, and an electronic device provided in the embodiments of the present disclosure, a video to be analyzed is acquired; then, on the basis of the video to be analyzed, transition detection is performed to obtain target transition information; then, on the basis of the video to be analyzed, material information is determined; and finally, on the basis of the target transition information and the material information, a video template corresponding to the video to be analyzed is generated. In this way, creation of a same-type video for any video can be supported.

Names of messages or information exchanged between devices in the embodiments of the present disclosure are for illustrative purposes only, and are not intended to limit the scope of the messages or information.

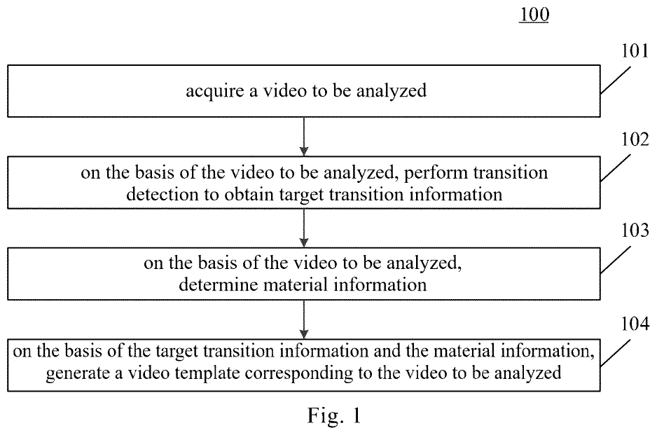

Please refer to FIG. 1, which illustrates a flow 100 of a video template generation method according to one embodiment of the present disclosure. The video template generation method comprises the following steps: step 101, acquiring a video to be analyzed.

In this embodiment, an execution subject of the video template generation method may acquire a video to be analyzed. The execution subject here may be a server, which may acquire a video satisfying a preset condition (for example, a video with hits greater than a preset hit threshold, a video of a preset video type, and the like), as the video to be analyzed.

Step 102, on the basis of the video to be analyzed, performing transition detection to obtain target transition information.

In this embodiment, the execution subject may, on the basis of the video to be analyzed, perform transition detection to obtain target transition information. Transition generally refers to transition or change between scenes in a video. Transition information may include a transition type, which may include, but is not limited to, at least one of: fade-in/fade-out, frame-out/frame-in, Iris, flip over, freeze, dissolve, multi-screen split, or use of a scenary shot. The transition information may also include a timestamp interval corresponding to a transition animation.

The execution subject here may input the video to be analyzed into a pre-trained transition recognition model, to obtain transition information in the video to be analyzed as the target transition information. The transition recognition model can be used for characterizing a correspondence between the video and the transition information in the video.

It should be noted that, if there are a plurality of transitions in the video to be analyzed, transition information of the plurality of transitions can be obtained.

Step 103, on the basis of the video to be analyzed, determining material information.

In this embodiment, the execution subject may, on the basis of the video to be analyzed, determine material information. The video to be analyzed is generally formed by a plurality of materials, such as emojis, and filters. The execution subject can recognize, from the video to be analyzed, the used emoji to obtain an emoji identification; or, the used filter to obtain a filter identification.

Step 104, on the basis of the target transition information and the material information, generating a video template corresponding to the video to be analyzed.

In this embodiment, the execution subject may, on the basis of the target transition information and the material information, generate a video template corresponding to the video to be analyzed. The execution subject can output the video template on the basis of a preset template protocol by using the target transition information and the material information, and packages the video template into a template resource bundle. According to the template protocol, the video template corresponding to the video may be generated by using information related to the video, such as the material information and the transition information.

Here, materials (e.g., filters, emojis, etc.) to be added in the video template and types of transitions to be used are generally agreed in the template protocol.

According to the method provided in the embodiment of the present disclosure, a video to be analyzed is acquired; then, on the basis of the video to be analyzed, transition detection is performed to obtain target transition information; then, on the basis of the video to be analyzed, material information is determined; and finally, on the basis of the target transition information and the material information, a video template corresponding to the video to be analyzed is generated. In this way, creation of a same-type video for any video can be supported.

In some optional implementations, the material information may comprise at least one of: text information, audio information, special effect information, or sticker information.

The text information may include text content. As an example, the execution subject may recognize text information from the video to be analyzed by using OCR (Optical Character Recognition). The OCR generally refers to a process of an electronic device examining a character printed on paper, determining its shape by detecting dark and light patterns, and then translating the shape into a computer word by using a character recognition method.

The audio information is generally an audio file, which is generally a file containing background music, and if the video to be analyzed contains human voice, the audio file may also be a file containing the background music and the human voice. As an example, the execution subject may, by calling an open-source video processing tool, FFMpeg (Fast Forward Mpeg (Moving Picture Experts Group)), analyze the audio file from the video to be analyzed. The FFmpeg is an open-source computer program that can be used for recording and converting digital audio and video, and can convert them into streams.

The special effect information may include a special effect type and a timestamp interval corresponding to the special effect. The special effect generally refers to a special effect produced by computer software that does not generally appear in reality. The execution subject may, by inputting the video to be analyzed into a pre-trained special effect recognition model, obtain corresponding special effect information. The special effect recognition model can be used for characterizing a correspondence between a video and special effect information of a special effect appearing in the video.

The sticker information may include a sticker type and a timestamp interval corresponding to the sticker. The sticker generally refers to a sticker decoration added to a video. The execution subject may, by inputting the video to be analyzed into a pre-trained sticker recognition model, obtain corresponding sticker information. The sticker recognition model can be used for characterizing a correspondence between a video and sticker information of a sticker appearing in the video.

By determining text, audio, special effect, sticker and other material information in the video to be analyzed, it is possible to make a same-type video generated by using the video template more in line with a presentation effect of the video to be analyzed.

In some optional implementations, the text information may comprise at least one of: a timestamp interval corresponding to text, a position coordinate corresponding to the text, a text font, or a text font size. That is, the execution subject may, from the video to be analyzed, recognize the timestamp interval corresponding to the text, the position coordinate corresponding to the text, the text font, and the text font size. Here, the timestamp interval corresponding to the text generally refers to a timestamp interval when the text appears in the video, and the position coordinate corresponding to the text may refer to a position coordinate of a text bounding box. In this way, richer text information can be recognized, making the generated text information in the video template more in line with the text information in the video to be analyzed.

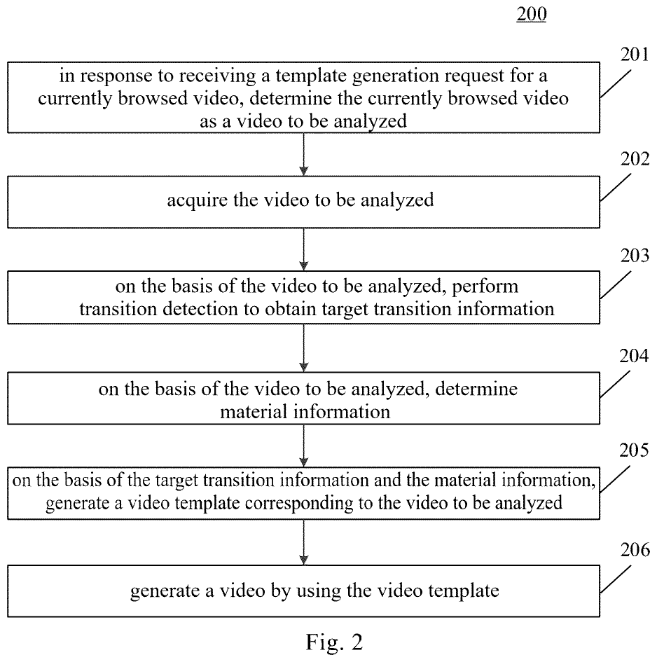

Continually refer to FIG. 2, which illustrates a flow 200 of a video template generation method according to another embodiment. The flow 200 of the video template generation method comprises the following steps:

step 201, in response to receiving a template generation request for a currently browsed video, determining the currently browsed video as a video to be analyzed.

In this embodiment, a user may browse a video (for example, a short video in short-video social software), and if the user is interested in a currently browsed video and wants to generate a same-type video similar to the currently browsed video, he may send a template generation request. As an example, a template generation icon may be presented in an interface for the currently browsed video, and the user may send the template generation request by a trigger operation on the template generation icon.

If an execution subject of the video template generation method receives the template generation request for the currently browsed video, the execution subject can determine the currently browsed video as the video to be analyzed.

Step 202, acquiring the video to be analyzed.

Step 203, on the basis of the video to be analyzed, performing transition detection to obtain target transition information.

Step 204, on the basis of the video to be analyzed, determining material information.

Step 205, on the basis of the target transition information and the material information, generating a video template corresponding to the video to be analyzed.

In this embodiment, the steps 202-205 can be performed in a manner similar to the steps 101-104, and are not repeated herein.

Step 206, generating a video by using the video template.

In this embodiment, the execution subject may generate a same-type video of the currently browsed video by using the video template generated in the step 205. As an example, after the video template is generated, the user may select a locally stored photo or video for uploading, or take a photo or video in real time for uploading, thereby generating a same-type video.

As can be seen from FIG. 2, compared with the embodiment corresponding to FIG. 1, in the flow 200 of the video template generation method in this embodiment, the steps of generating a video template of the video currently browsed by the user and generating a same-type video are embodied. Therefore, the solution described in the embodiment can meet a replication requirement of the user for a same-type video of any browsed video when the user browses the video.

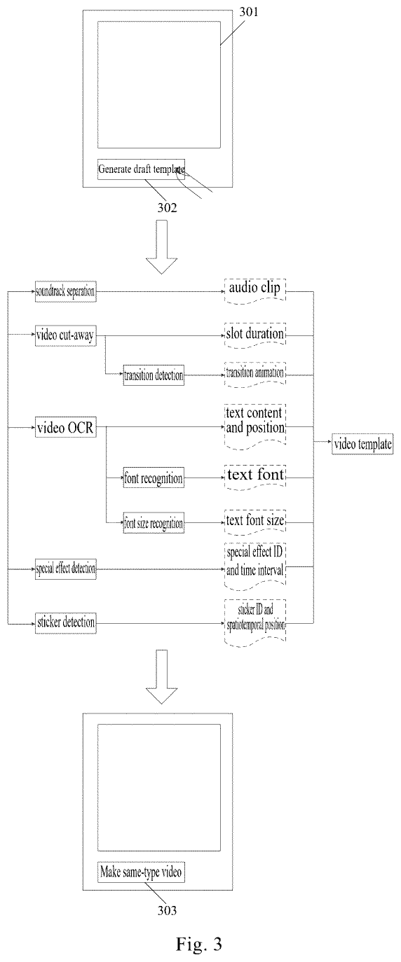

Further refer to FIG. 3, which is a schematic diagram of an application scenario for the video template generation method according to this embodiment. In the application scenario of FIG. 3, when the user browses a video 301 in a short video application, a “Generate draft template” icon 302 is presented in a browsing interface. If the user clicks the “Generate draft template” icon 302, the currently browsed video 301 may be analyzed. Here, the analyzing operation may include eight operations of soundtrack separation, video cut-away, transition detection, video OCR, font recognition, font size recognition, special effect detection, and sticker detection. By the soundtrack separation, an audio clip can be analyzed from the video 301; by the video cut-away, a slot duration can be recognized from the video 301; after the video cut-away, by the transition detection, a transition animation can be recognized from a scene switching clip; by the video OCR, text content and text position can be recognized from the video 301; by font identification, a text font can be recognized from a text area; by the font size identification, a text font size can be recognized from the text area; by the special effect detection, a special effect ID and time interval when a special effect is presented can be recognized from the video 301; by the sticker detection, a sticker ID and spatiotemporal position, i.e. a position where a sticker is presented and a time interval when it is presented, can be recognized from the video 301; and finally, an editing template corresponding to the video 301 may be generated by using the audio clip, the slot duration, the transition animation, the text content and position, the text font, the text font size, the special effect ID and time interval, the sticker ID and spatiotemporal position. If the user performs a click operation on a “Make same-type video” icon 303, a same-type video may be generated by using the generated video template.

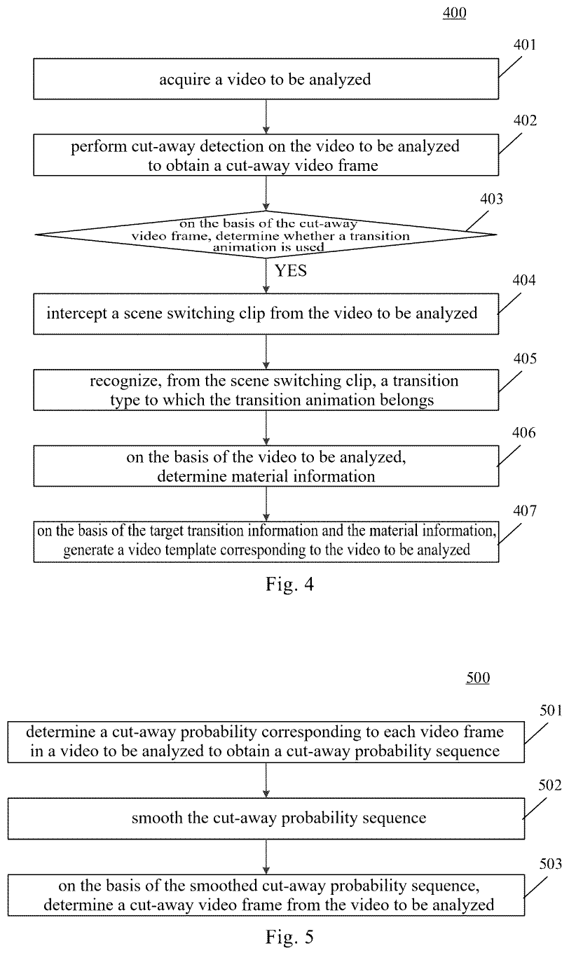

Please refer to FIG. 4, which illustrates a flow 400 of a video template generation method according to another embodiment. The flow 400 of the video template generation method comprises the following steps: step 401, acquiring a video to be analyzed.

In this embodiment, the step 401 may be performed in a manner similar to the step 101, and is not repeated herein.

Step 402, performing cut-away detection on the video to be analyzed to obtain a cut-away video frame.

In this embodiment, an execution subject of the video template generation method may perform cut-away detection on the video to be analyzed to obtain a cut-away video frame. Here, the execution subject may perform cut-away detection on the video to be analyzed in a manner of clipper cut-away detection. Detection steps of the clipper cut-away detection generally include: extracting an image feature from a video frame of the video to be analyzed; for each video frame, determining a similarity between the video frame and an adjacent video frame within a time window to obtain a correlation matrix; flattening the correlation matrix into a vector, and inputting the vector into a pre-trained binary classification model (e.g., MLP (Multilayer Perceptron)), to obtain a classification result, the classification result being used for indicating whether the video frame is the cut-away video frame. As an example, a classification result of “1” or “T” may be used for indicating that the video frame is the cut-away video frame, and a classification result of “0” or “F” may be used for indicating that the video frame is not the cut-away video frame.

Step 403, on the basis of the cut-away video frame, determining whether a transition animation is used.

In this embodiment, the execution subject may, on the basis of the cut-away video frame detected in the step 402, determine whether a transition animation is used. A transition animation is often used between two scenes in order to make a transition between the two scenes more natural, but there is also a case where no transition animation is used, with directly switching from one scene to another, and this scene switching can be referred to as straight cut.

Specifically, the execution subject may determine a matching degree between the cut-away video frame and an adjacent frame of the cut-away video frame. Here, the matching degree between the cut-away video frame and the adjacent frame of the cut-away video frame may be a matching degree between the cut-away video frame and a previous adjacent frame of the cut-away video frame, or a matching degree between the cut-away video frame and a following adjacent frame of the cut-away video frame, or an average of the matching degree between the cut-away video frame and the previous adjacent frame of the cut-away video frame and the matching degree between the cut-away video frame and the following adjacent frame of the cut-away video frame.

If the matching degree is greater than or equal to a preset matching degree threshold, it is indicated that a difference between two adjacent frames is small, at this time, it can be determined that the transition animation is used, and step 404 is executed; and if the matching degree is less than the matching degree threshold, it is indicated that a difference between two adjacent frames is large, and at this time, it can be determined that no transition animation is used.

Step 404, if the transition animation is used, intercepting a scene switching clip from the video to be analyzed.

In this embodiment, if it is determined in the step 403 that the transition animation is used, the execution subject may intercept a scene switching clip from the video to be analyzed. The execution subject may intercept, from the video to be analyzed, a preset number of previous and following video frames of the cut-away video frame, which are combined with the cut-away video frame to form the scene switching clip.

As an example, previous five frames and following five frames adjacent to the cut-away video frame may be intercepted from the video to be analyzed, the previous five frames, the cut-away video frame, and the following five frames forming a scene switching clip.

It should be noted that, the number of the intercepted video frames may be set according to actual conditions.

Step 405, recognizing, from the scene switching clip, a transition type to which the transition animation belongs.

In this embodiment, the execution subject may recognize, from the scene switching clip, a transition type to which the transition animation belongs. Specifically, the execution agent may input the scene switching clip into a pre-trained transition type recognition model, to obtain the transition type to which the transition animation belongs. The transition type recognition model can be used for characterizing a correspondence between a scene change video and a transition type to which the scene change video belongs.

Step 406, on the basis of the video to be analyzed, determining material information.

Step 407, on the basis of the target transition information and the material information, generating a video template corresponding to the video to be analyzed.

In this embodiment, the steps 406 and 407 can be performed in a manner similar to the steps 103 and 104, and are not repeated herein.

As can be seen from FIG. 4, compared with the embodiment corresponding to FIG. 1, in the flow 400 of the video template generation method in this embodiment, the steps of detecting a cut-away video frame, determining whether a transition animation is used, in the case where the transition animation is used, intercepting a scene switching clip, and recognizing a transition type therefrom are embodied. Therefore, the solution described in this embodiment provides a transition type recognition mode, improving the accuracy of the transition type recognition.

In some optional implementations, the execution subject may determine whether to use a transition animation on the basis of the cut-away video frame by: performing a differential operation on a cut-away probability corresponding to the cut-away video frame and a cut-away probability corresponding to the adjacent frame of the cut-away video frame. The differential operation here is generally first-order difference, which refers to a difference between two consecutive adjacent terms in a discrete function. When an independent variable changes from x to x+1, a variation Δyx=y(x+1)−y(x), (x=0, 1, 2 . . . ) of a function y=y(x) is referred as first-order difference of the function y(x) at the point x.

As an example, the execution subject may determine a difference between the cut-away probability corresponding to the cut-away video frame and a cut-away probability corresponding to a previous adjacent frame of the cut-away video frame as a differential result; or determine a difference between the cut-away probability corresponding to the cut-away video frame and a cut-away probability corresponding to a following adjacent frame of the cut-away video frame as a differential result; or determine an average of differences between the cut-away probability corresponding to the cut-away video frame and cut-away probabilities corresponding to previous and following two adjacent frames of the cut-away video frame as a differential result.

Then, on the basis of the differential result, it may be determined whether the transition animation is used. Here, it may be determined whether the differential result is less than a preset differential threshold, and if the differential result is less than the differential threshold, it may be determined that the transition animation is used. Because the difference between the cut-away probability corresponding to the cut-away video frame and the cut-away probability corresponding to the previous/following frame is large in straight cut, a first-order differential result of the cut-away video frame in the straight cut is large, while a first-order differential result of the cut-away video frame in scene transition is small. In this way, the use of the transition animation can be more accurately determined.

In some optional implementations, the execution subject may perform the differential operation on the cut-away probability corresponding to the cut-away video frame and the cut-away probability corresponding to the adjacent frame of the cut-away video frame, and on the basis of the differential result, determine whether the transition animation is used, by: determining a difference between the cut-away probability corresponding to the cut-away video frame and a cut-away probability corresponding to a previous video frame of the cut-away video frame as a first difference, and determining a ratio of the first difference to the cut-away probability corresponding to the previous video frame as a first ratio, that is, the first ratio=(cut-away probability corresponding to the cut-away video frame-cut-away probability corresponding to the previous video frame)/cut-away probability corresponding to the previous video frame. Then, it is possible to determine a difference between the cut-away probability corresponding to the cut-away video frame and a cut-away probability corresponding to a following video frame of the cut-away video frame as a second difference, and determine a ratio of the second difference to the cut-away probability corresponding to the following video frame as a second ratio, that is, the second ratio=(cut-away probability corresponding to the cut-away video frame−cut-away probability corresponding to the following video frame)/cut-away probability corresponding to the following video frame. Then, it is possible to determine an average of the first ratio and the second ratio as a differential result. Finally, it is possible to compare the differential result with a preset differential threshold, and if the differential result is less than the differential threshold, determine that the transition animation is used. In this way, the accuracy of determining the use of the transition animation can be further improved.

In some optional implementations, after recognizing the transition type to which the transition animation belongs from the scene switching clip, the execution subject may acquire an overlap identification corresponding to the transition type; the execution subject generally has therein stored a correspondence table of a correspondence between a transition type and an overlap identification, so that it may search the correspondence table for the overlap identification corresponding to the transition type. The overlap identification is generally used for indicating whether the transition animation has an overlap with the slot content. As an example, an overlap identification of “1” or “T” may indicate that the transition animation has an overlap with the slot content; and an overlap identification of “0” or “F” may indicate that the transition animation has no overlap with the slot content. A transition type of “Dissolve” is to fade a previous scene slowly and intensify a following scene slowly, so that an overlap identification corresponding to the transition type of “Dissolve” is usually “1”. The video template can be formed by a plurality of slots, and the user can upload a material (such as an image, and video) to fill the slot in the video template, thereby generating a video. If the overlap identification indicates that the transition animation has an overlap with the slot content, the execution subject may compensate for a duration of the slot content.

As an example, if a duration of a previous slot content is 2 seconds and a duration of a following slot content is 2 seconds, and a transition animation of 0.5 seconds exists between the two slot contents, an actually rendered duration is 3.5 seconds (the duration of 0.5 seconds of the transition animation will be removed). In order to maintain that the original video template has a duration of 4 seconds, if the transition animation overlaps with the previous slot content, the previous slot content needs to be compensated by a duration of 0.5 seconds. In this way, the duration of the original video template can be maintained even in the presence of the overlap transition.

Continually refer to FIG. 5, which illustrates a flow 500 of detecting a cut-away video frame in a video template generation method according to one embodiment. The flow 500 of detecting a cut-away video frame comprises the following steps: step 501, determining a cut-away probability corresponding to each video frame in a video to be analyzed to obtain a cut-away probability sequence.

In this embodiment, an execution subject of the video template generation method may determine a cut-away probability corresponding to each video frame in a video to be analyzed to obtain a cut-away probability sequence.

Specifically, for each video frame in the video to be analyzed, the execution subject may determine a visual difference between the video frame and an adjacent video frame to obtain a difference. Then, it may acquire a cut-away probability corresponding to the difference. The execution subject may have therein stored a correspondence table of a correspondence between the difference and the cut-away probability, and may query the cut-away probability corresponding to the difference from the correspondence table. Then, the cut-away probability sequence corresponding to a video frame sequence may be generated, wherein the video frame sequence is in an order that the video frames are arranged from front to back in the video to be analyzed.

Step 502, smoothing the cut-away probability sequence.

In this embodiment, the execution subject may smooth the cut-away probability sequence. As an example, the cut-away probability sequence may be smoothed by using a moving window average smoothing algorithm. According to the moving window average smoothing algorithm, a smoothing window is moved on data for averaging, thereby denoising the data.

Step 503, on the basis of the smoothed cut-away probability sequence, determining a cut-away video frame from the video to be analyzed.

In this embodiment, the execution subject may determine a cut-away video frame from the video to be analyzed on the basis of the smoothed cut-away probability sequence.

Here, the execution subject may compare the cut-away probability in the cut-away probability sequence with a preset probability threshold, to intercept at least one cut-away interval from the video frame sequence, each cut-away interval being formed by consecutive video frames with the cut-away probability greater than the probability threshold. Then, for each of the at least one cut-away interval, a video frame corresponding to a maximum cut-away probability in the cut-away interval may also be determined as the cut-away video frame.

According to the method provided in the embodiment of the present disclosure, a cut-away probability corresponding to each video frame in the video to be analyzed is determined to obtain a cut-away probability sequence; then, the cut-away probability sequence is smoothed; and then, a cut-away video frame is determined from the video to be analyzed on the basis of the smoothed cut-away probability sequence. The cut-away probability is denoised by the smoothing operation, reducing missed detection, multiple detection, and the like of the cut-away video frame.

In some optional implementations, the execution subject may determine the cut-away probability corresponding to each video frame in the video to be analyzed to obtain the cut-away probability sequence, by: inputting the video frame sequence of the video to be analyzed into a pre-trained shot segmentation detection model, to obtain the cut-away probability sequence corresponding to the video frame sequence. The shot segmentation detection model can be used for characterizing a correspondence between a video frame and a cut-away probability corresponding to the video frame. The shot segmentation detection model may be a TransNetV2 model, which has an input of a video, and which compresses each frame of the video to a uniform small size, and into which every 100 frames as one clip (but a result of only middle 50 frames is taken, and previous and following 25 frames are similar to overlap) are inputted, to obtain a probability of whether each frame is a boundary frame; after the complete clips of the video are calculated, it is determined that a frame with a probability greater than a threshold (0.5 by default) is a shot boundary frame. In this way, the cut-away video frame is detected by using the shot segmentation detection model, improving the accuracy of the detection of the cut-away video frame.

In some optional implementations, the execution subject may determine the cut-away video frame from the video to be analyzed on the basis of the smoothed cut-away probability sequence, by: acquiring a target threshold and a window width of a sliding window when the cut-away probability sequence is smoothed, wherein the target threshold is generally an original threshold used by the shot segmentation detection model when determining whether a certain video frame is the cut-away video frame. Then, a ratio of the target threshold to the window width may be determined as an updated threshold. As an example, if the target threshold is 0.5 and the window width is 5, the updated threshold is 0.1. Then, the smoothed cut-away probability sequence may be compared with the updated threshold to determine the cut-away video frame from the video to be analyzed. Specifically, a video frame with the smoothed cut-away probability greater than the updated threshold may be selected from the video to be analyzed to form at least one video interval, and a video frame corresponding to a maximum smoothed cut-away probability may be selected from each video interval as the cut-away video frame. In this way, the threshold of the shot segmentation detection model for detecting the cut-away video frame can be adaptively adjusted after the smoothing, so that the cut-away video frame can be more accurately determined.

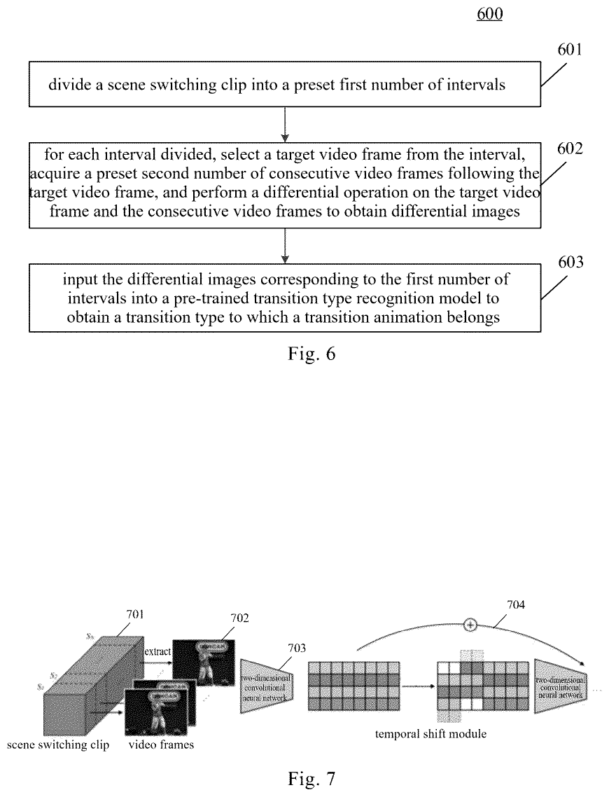

Please refer to FIG. 6, which illustrates a flow 600 of recognizing a transition type in a video template generation method according to one embodiment. The flow 600 of recognizing a transition type comprises the following steps: step 601, dividing a scene switching clip into preset first number of intervals.

In this embodiment, an execution subject of the video template generation method may divide a scene switching clip into a preset first number of intervals. Here, the scene switching clip may be equally divided into the first number of intervals, for example, 10 intervals.

Step 602, for each interval divided, selecting a target video frame from the interval, acquiring a preset second number of consecutive video frames following the target video frame, and performing a differential operation on the target video frame and the consecutive video frames to obtain differential images.

In this embodiment, for each interval divided, the execution subject may select a target video frame from the interval. As an example, one video frame may be arbitrarily selected from the interval as the target video frame.

Then, a preset second number (for example, 4) of consecutive video frames following the target video frame may be acquired, and a differential operation may be performed on the target video frame and the consecutive video frames to obtain differential images. The differential images are images formed by image subtraction in a target scene at consecutive time points, and generalized differential images are defined as differences between images formed in the target scene at time points tk and tk+L. The differential image is obtained by image subtraction in target scene at adjacent time points, so that the change in the target scene over time can be obtained.

Step 603, inputting the differential images corresponding to the first number of intervals into a pre-trained transition type recognition model, to obtain a transition type to which a transition animation belongs.

In this embodiment, the execution subject may input the differential images corresponding to the first number of intervals into a pre-trained transition type recognition model, to obtain a transition type to which a transition animation belongs. The transition type recognition model can be used for characterizing a correspondence between differential images corresponding to a video interval and a transition type of the video interval.

Specifically, the execution subject may serially connect the differential images corresponding to the first number of intervals in a channel dimension and then input them into the transition type recognition model. The transition type recognition model may be a TSM (Temporal Shift Module), which shifts a channel forward and backward along a time dimension. Information of an adjacent frame after the shift is mixed with information of the current frame. A convolution operation is formed by an accumulation of shifts and multiplications. It is shifted by ±1 in the time dimension and multiplications are accumulated from the time dimension to the channel dimension. This is equivalent to a time domain convolution with a kernel size of 3. In implementations, it is only needed to shift an address pointer, without data shift, ensuring the efficiency.

According to the method provided in the above embodiment of the present disclosure, a scene switching clip is divided into a plurality of intervals; then, for each interval divided, a target video frame is selected from the interval, a plurality of consecutive video frames following the target video frame are acquired, and a differential operation is performed on the target video frame and the consecutive video frames to obtain differential images; then, differential images corresponding to the first number of intervals are inputted into a pre-trained transition type recognition model (for example, a TSM model), to obtain a transition type to which a transition animation belongs. In this way, the transition type is recognized by the temporal differential and the TSM model, ensuring the recognition efficiency while ensuring the accuracy of the recognition of the transition type.

Continually refer to FIG. 7, which is a schematic diagram of an application scenario for recognizing a transition type in the video template generation method according to this embodiment. In the application scenario of FIG. 7, a scene switching clip indicated by an icon 701 is switched into N intervals equally divided, S1, S2 . . . SN; for each of the N intervals, a target video frame and its following 4 consecutive video frames are extracted from the interval to obtain 5 consecutive video frames, as shown by an icon 702; the 5 consecutive video frames corresponding to each interval are inputted to a two-dimensional convolutional neural network (2D Conv) shown by an icon 703, to obtain differential images corresponding to each interval. The differential images corresponding to each interval are serially connected in a channel dimension and then inputted into a temporal shift module (TSM) indicated by an icon 704, to obtain a transition type to which a transition animation of the scene switching clip belongs.

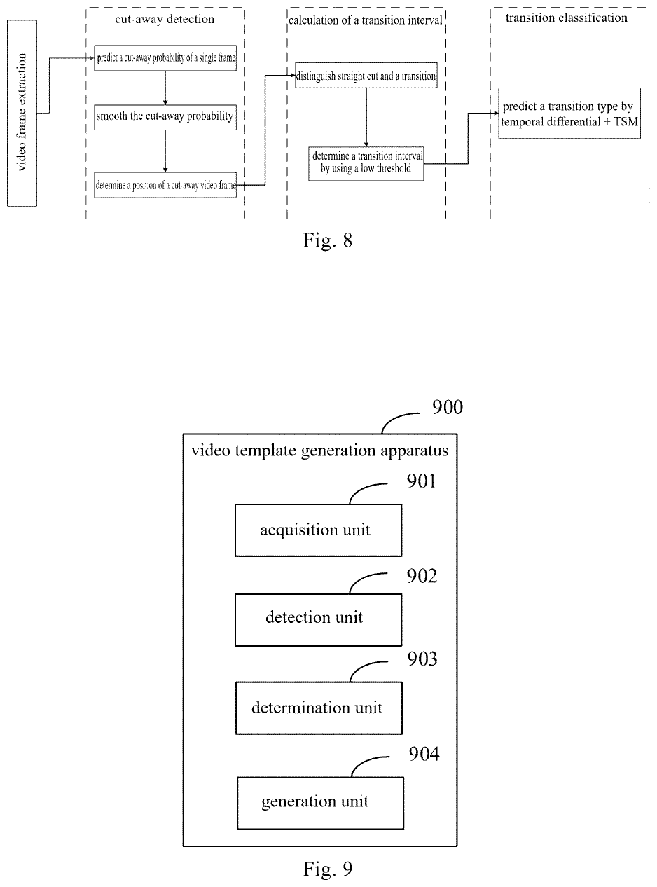

Further refer to FIG. 8, which is a schematic diagram of an application scenario for detecting transition information in the video template generation method according to this embodiment. In the application scenario of FIG. 8, a video frame is extracted from a video to be analyzed, and cut-away detection on the extracted video frame is performed, including the steps of: predicting a cut-away probability of a single video frame, smoothing the cut-away probability, and determining a position of a cut-away video frame. Then, a transition interval is calculated, which mainly includes: distinguishing straight cut and transition, and if it is determined that a transition animation is used, determining a transition interval by using a low threshold. Then, transition classification is performed and a transition type is predicted by temporal differential and the TSM model.

Further referring to FIG. 9, as an implementation of the methods shown in the above figures, the present application provides an embodiment of a video template generation apparatus; the apparatus embodiment corresponds to the method embodiment shown in FIG. 1, and the apparatus may be specifically applied to various electronic devices.

As shown in FIG. 9, the video template generation apparatus 900 of this embodiment comprises: an acquisition unit 901, a detection unit 902, a determination unit 903, and a generation unit 904. The acquisition unit 901 is configured to acquire a video to be analyzed; the detection unit 902 is configured to, on the basis of the video to be analyzed, perform transition detection to obtain target transition information; the determination unit 903 is configured to, on the basis of the video to be analyzed, determine material information; the generation unit 904 is configured to, on the basis of the target transition information and the material information, generate a video template corresponding to the video to be analyzed.

In this embodiment, for specific processing of the acquisition unit 901, the detection unit 902, the determination unit 903 and the generation unit 904 of the video template generation apparatus 900, reference may be made to the steps 101, 102, 103 and 104 in the corresponding embodiment of FIG. 1.

In some optional implementations, the apparatus further comprises: a video determination unit (not shown in the figure) and a video generation unit (not shown in the figure). The video determination unit is configured to, in response to receiving a template generation request for a currently browsed video, determine the currently browsed video as the video to be analyzed. The video generation unit is configured to generate a video by using the video template.

In some optional implementations, the detection unit 902 is further configured to perform transition detection on the basis of the video to be analyzed to obtain target transition information by: performing cut-away detection on the video to be analyzed to obtain a cut-away video frame; on the basis of the cut-away video frame, determining whether a transition animation is used; if the transition animation is used, intercepting a scene switching clip from the video to be analyzed; and recognizing, from the scene switching clip, a transition type to which the transition animation belongs.

In some optional implementations, the detection unit 902 is further configured to perform cut-away detection on the video to be analyzed to obtain a cut-away video frame by: determining a cut-away probability corresponding to each video frame in the video to be analyzed to obtain a cut-away probability sequence; smoothing the scope cutting probability sequence; and on the basis of the smoothed cut-away probability sequence, determining the cut-away video frame from the video to be analyzed.

In some optional implementations, the detection unit 902 is further configured to determine a cut-away probability corresponding to each video frame in the video to be analyzed to obtain a cut-away probability sequence by: inputting a video frame sequence of the video to be analyzed into a pre-trained shot segmentation detection model, to obtain the cut-away probability sequence corresponding to the video frame sequence.

In some optional implementations, the detection unit 902 is further configured to determine the cut-away video frame from the video to be analyzed on the basis of the smoothed cut-away probability sequence by: acquiring a target threshold and a window width of a sliding window when the cut-away probability sequence is smoothed, wherein the target threshold is an original threshold for detecting the cut-away video frame; determining a ratio of the target threshold to the window width as an updated threshold; and comparing the smoothed cut-away probability sequence with the updated threshold to determine the cut-away video frame from the video to be analyzed.

In some optional implementations, the detection unit 902 is further configured to determine whether a transition animation is used on the basis of the cut-away video frame by: performing a differential operation on a cut-away probability corresponding to the cut-away video frame and a cut-away probability corresponding to an adjacent frame of the cut-away video frame, and on the basis of a differential result, determining whether the transition animation is used.

In some optional implementations, the detection unit 902 is further configured to perform a differential operation on a cut-away probability corresponding to the cut-away video frame and a cut-away probability corresponding to an adjacent frame of the cut-away video frame, and on the basis of a differential result, determine whether the transition animation is used, by: determining a difference between the cut-away probability corresponding to the cut-away video frame and a cut-away probability corresponding to a previous video frame of the cut-away video frame as a first difference, and determining a ratio of the first difference to the cut-away probability corresponding to the previous video frame as a first ratio; determining a difference between the cut-away probability corresponding to the cut-away video frame and a cut-away probability corresponding to a following video frame of the cut-away video frame as a second difference, and determining a ratio of the second difference to the cut-away probability corresponding to the following video frame as a second ratio; determining an average of the first ratio and the second ratio as the differential result; and if the differential result is less than a preset differential threshold, determining that the transition animation is used.

In some optional implementations, the detection unit 902 is further configured to recognize, from the scene switching clip, a transition type to which the transition animation belongs, by: dividing the scene switching clip into a preset first number of intervals; for each interval divided, selecting a target video frame from the interval, acquiring a preset second number of consecutive video frames following the target video frame, and performing a differential operation on the target video frame and the consecutive video frames to obtain differential images; and inputting the differential images corresponding to the first number of intervals into a pre-trained transition type recognition model to obtain the transition type to which the transition animation belongs.

In some optional implementations, the apparatus further comprises: an overlap identification acquisition unit (not shown in the figure) and a compensation unit (not shown in the figure). The overlap identification acquisition unit is configured to acquire an overlap identification corresponding to the transition type, wherein the overlap identification is used for indicating whether the transition animation has an overlap with a slot content; and the compensation unit is configured to, if the overlap identification indicates that the transition animation has an overlap with the slot content, compensate a duration of the slot content.

In some optional implementations, the material information comprises at least one of: text information, audio information, special effect information, or sticker information.

In some optional implementations, the text information further comprises at least one of: a timestamp interval corresponding to text, a position coordinate corresponding to the text, a text font, or a text font size.

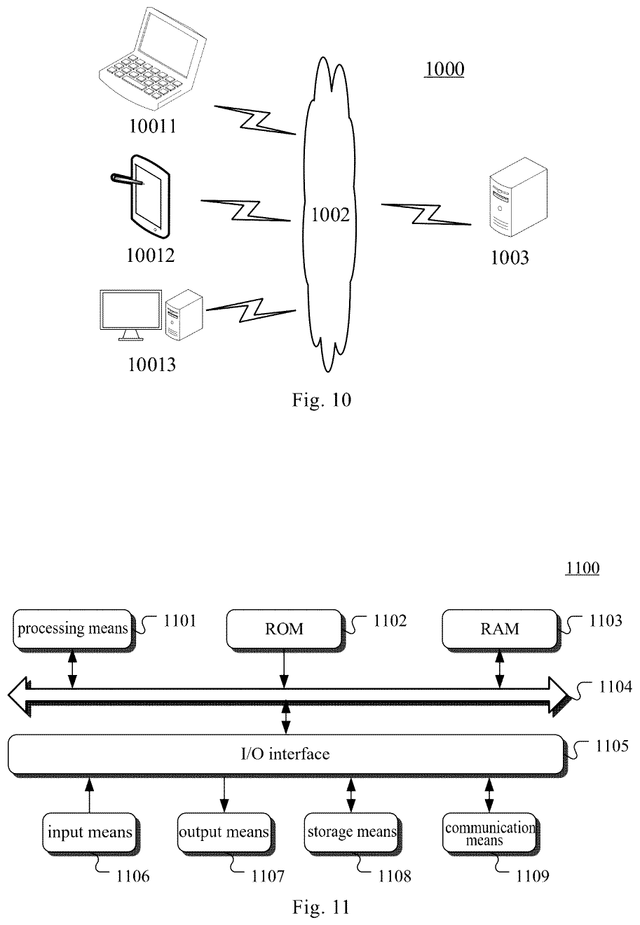

Please refer to FIG. 10, which illustrates an exemplary architecture 1000 of a system to which a video template generation method may be applied according to an embodiment of the present disclosure.

As shown in FIG. 10, the system architecture 1000 may include terminal devices 10011, 10012, 10013, a network 1002, and a server 1003. The network 1002 is used for providing a medium of communication links between the terminal devices 10011, 10012, 10013 and the server 1003. The network 1002 may include various connection types, such as wired, wireless communication links, or optical fiber cables.

A user may interact with the server 1003 over the network 1002 by using the terminal devices 10011, 10012, 10013, to send or receive a message or the like, for example, the server 1003 may send an editing template to the terminal devices 10011, 10012, 10013 of the user. On the terminal devices 10011, 10012, 10013, various communication client applications, such as a short video application, a video editing application, instant messaging software, etc., can be installed.

The user can browse a short video in a short video application by using the terminal devices 10011, 10012, and 10013, and if the user sends a template generation request for a currently browsed video, the terminal devices 10011, 10012, and 10013 may acquire the currently browsed video as a video to be analyzed; then, may perform transition detection on the basis of the video to be analyzed to obtain target transition information; then, may determine material information on the basis of the video to be analyzed; and finally, may generate a video template corresponding to the video to be analyzed on the basis of the target transition information and the material information. The user can generate a same-type video by using the generated video template.

The terminal devices 10011, 10012, and 10013 may be hardware or software. When the terminal devices 10011, 10012, 10013 are hardware, they may be various electronic devices having a display and supporting information interaction, including, but not limited to, smartphones, tablets, laptops, and the like. When the terminal devices 10011, 10012, and 10013 are software, they can be installed in the above-listed electronic devices. They may be implemented as a plurality of software or software modules (e.g., a plurality of software or software modules for providing distributed services), or as a single software or software module. It is not specifically limited herein.

The server 1003 may be a server providing various services. For example, it may be a backend server analyzing a video to be analyzed. The server 1003 may acquire a video to be analyzed; then, may perform transition detection on the basis of the video to be analyzed to obtain target transition information; then, may determine material information on the basis of the video to be analyzed; and finally, may generate a video template corresponding to the video to be analyzed on the basis of the target transition information and the material information. When the video browsed by the user is an analyzed video, the video template can be presented for making a same-type video by the user.

It should be noted that the server 1003 may be hardware or software. When the server 1003 is hardware, it may be implemented as a distributed server cluster formed by a plurality of servers, or as a single server. When the server 1003 is software, it may be implemented as a plurality of software or software modules (which are used for, e.g., providing distributed services), or it may be implemented as a single software or software module. It is not specifically limited herein.

It should be further noted that, the video template generation method provided in the embodiment of the present disclosure may be executed by the terminal devices 10011, 10012, and 10013, and at this time, the video template generation apparatus may be provided in the terminal devices 10011, 10012, and 10013; and the video template generation method may be executed by the server 1003, and at this time, the video template generation apparatus may be provided in the server 1003.

It should be understood that the number of the terminal devices, networks, and servers in FIG. 10 are merely illustrative. There may be any number of the terminal devices, networks, and servers according to implementation requirements.

Refer to FIG. 11 below, which illustrates a schematic structural diagram of an electronic device (e.g., a server or terminal device in FIG. 10) 1100 suitable for implementing an embodiment of the present disclosure. The terminal device in the embodiment of the present disclosure may include, but is not limited to, a mobile terminal such as a mobile phone, a laptop, a digital broadcast receiver, a PDA (Personal Digital Assistant), a PAD (tablet), a PMP (Portable Multimedia Player), and a vehicle-mounted terminal (e.g., a vehicle-mounted navigation terminal), and a fixed terminal such as a digital TV, and a desktop. The electronic device shown in FIG. 11 is only an example, and should not bring any limitation to the functions and the scope of use of the embodiments of the present disclosure.

As shown in FIG. 11, the electronic device 1100 may include a processing means (e.g., a central processing unit, a graphics processing unit, etc.) 1101 that may perform various appropriate actions and processes according to a program stored in a read-only memory (ROM) 1102 or a program loaded from a storage means 1108 into a random access memory (RAM) 1103. In the RAM 1103, various programs and data required for the operation of the electronic device 1100 are also stored. The processing means 1101, the ROM 1102, and the RAM 1103 are connected to each other via a bus 1104. An input/output (I/O) interface 1105 is also connected to the bus 1104.

Generally, the following means may be connected to the I/O interface 1105: an input means 1106, including, for example, a touch screen, touch pad, keyboard, mouse, camera, microphone, accelerometer, gyroscope, etc.; an output means 1107, including, for example, a liquid crystal display (LCD), speaker, vibrator, etc.; the storage means 1108, including, for example, a magnetic tape, hard disk, etc.; and a communication means 1109. The communication means 1109 may allow the electronic device 1100 to communicate wirelessly or by wire with other devices to exchange data. While FIG. 11 illustrates the electronic device 1100 having various means, it should be understood that there is no requirement that all the illustrated means are implemented or provided. More or fewer means may be alternatively implemented or provided. Each block shown in FIG. 11 may represent one means or may represent a plurality of means as needed.

In particular, according to the embodiment of the present disclosure, the processes described above with reference to the flow diagrams may be implemented as a computer software program. For example, the embodiment of the present disclosure comprises a computer program product comprising a computer program carried on a computer-readable medium, the computer program containing program code for performing the method illustrated by the flow diagrams. In such an embodiment, the computer program may be downloaded and installed from a network by the communication means 1109, or installed from the storage means 1108, or installed from the ROM 1102. The computer program, when executed by the processing means 1101, performs the above functions defined in the method of the embodiment of the present disclosure. It should be noted that the computer-readable medium according to the embodiment of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the embodiment of the present disclosure, the computer-readable storage medium may be any tangible medium containing or storing a program, wherein the program can be used by or in conjunction with an instruction execution system, apparatus, or device. However, in the embodiment of the present disclosure, the computer-readable signal medium may include a data signal propagated in baseband or as part of a carrier wave, in which computer-readable program code is carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program code contained on the computer-readable medium may be transmitted using any appropriate medium, including but not limited to: a wire, an optical cable, RF (Radio Frequency), etc., or any suitable combination of the foregoing.

The computer-readable medium may be contained in the electronic device; or may exist separately without being assembled into the electronic device. The computer-readable medium has thereon carried one or more programs which, when executed by the electronic device, cause the electronic device to: acquire a video to be analyzed; on the basis of the video to be analyzed, perform transition detection to obtain target transition information; on the basis of the video to be analyzed, determine material information; and on the basis of the target transition information and the material information, generate a video template corresponding to the video to be analyzed.

Computer program code for performing the operation of the embodiment of the present disclosure may be written in one or more programming languages or a combination thereof, wherein the programming language includes an object-oriented programming language such as Java, Smalltalk, and C++, and also includes a conventional procedural programming language, such as a “C” language or a similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of code, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved units described in the embodiments of the present disclosure may be implemented by software or hardware. The described units may also be provided in a processor, which may be described as, for example: a processor comprising an acquisition unit, a detection unit, a determination unit, and a generation unit. The names of these units do not in some cases constitute limitations to the units themselves, for example, the acquisition unit may also be described as “a unit configured to acquire a video to be analyzed”.

The foregoing description is only illustration of the preferred embodiments of the present disclosure and the technical principles employed. It should be appreciated by those skilled in the art that the inventive scope involved in the embodiments of the present disclosure is not limited to the technical solutions formed by specific combinations of the above technical features, but also encompasses other technical solutions formed by arbitrary combinations of the above technical features or equivalent features thereof without departing from the above invention concepts, for example, a technical solution formed by performing mutual replacement between the above features and technical features having similar functions to those disclosed (but not limited to) in the embodiments of the present disclosure.

1. A video template generation method, comprising:
acquiring a video to be analyzed;
on the basis of the video to be analyzed, performing transition detection to obtain target transition information;
on the basis of the video to be analyzed, determining material information; and
on the basis of the target transition information and the material information, generating a video template corresponding to the video to be analyzed.

2. The method according to claim 1, wherein before the acquiring a video to be analyzed, the method further comprises:
in response to receiving a template generation request for a currently browsed video, determining the currently browsed video as the video to be analyzed; and
after the generating a video template corresponding to the video to be analyzed on the basis of the target transition information and the material information, the method further comprises:
generating a video by using the video template.

3. The method according to claim 1, wherein the performing transition detection to obtain target transition information on the basis of the video to be analyzed, comprises:
performing cut-away detection on the video to be analyzed to obtain a cut-away video frame;
on the basis of the cut-away video frame, determining whether a transition animation is used;
in response that determining the transition animation is used, intercepting a scene switching clip from the video to be analyzed; and
recognizing, from the scene switching clip, a transition type to which the transition animation belongs.

4. The method according to claim 3, wherein the performing cut-away detection on the video to be analyzed to obtain a cut-away video frame, comprises:
determining a cut-away probability corresponding to each video frame in the video to be analyzed, to obtain a cut-away probability sequence;
smoothing the cut-away probability sequence; and
on the basis of the smoothed cut-away probability sequence, determining the cut-away video frame from the video to be analyzed.

5. The method according to claim 4, wherein the determining a cut-away probability corresponding to each video frame in the video to be analyzed, to obtain a cut-away probability sequence, comprises:
inputting a video frame sequence of the video to be analyzed into a pre-trained shot segmentation detection model, to obtain the cut-away probability sequence corresponding to the video frame sequence.

6. The method according to claim 4, wherein the determining the cut-away video frame from the video to be analyzed on the basis of the smoothed cut-away probability sequence, comprises:
acquiring a target threshold and a window width of a sliding window for smoothing the cut-away probability sequence, wherein the target threshold is an original threshold for detecting the cut-away video frame;
determining a ratio of the target threshold to the window width as an updated threshold; and
comparing the smoothed cut-away probability sequence with the updated threshold, to determine the cut-away video frame from the video to be analyzed.

7. The method according to claim 3, wherein the determining whether a transition animation is used on the basis of the cut-away video frame, comprises:
performing a differential operation on a cut-away probability corresponding to the cut-away video frame and a cut-away probability corresponding to an adjacent frame of the cut-away video frame, and on the basis of a differential result, determining whether the transition animation is used.

8. The method according to claim 7, wherein the performing a differential operation on a cut-away probability corresponding to the cut-away video frame and a cut-away probability corresponding to an adjacent frame of the cut-away video frame, and on the basis of a differential result, determining whether the transition animation is used, comprises:
determining a difference between the cut-away probability corresponding to the cut-away video frame and a cut-away probability corresponding to a previous video frame of the cut-away video frame as a first difference, and determining a ratio of the first difference to the cut-away probability corresponding to the previous video frame as a first ratio;
determining a difference between the cut-away probability corresponding to the cut-away video frame and a cut-away probability corresponding to a following video frame of the cut-away video frame as a second difference, and determining a ratio of the second difference to the cut-away probability corresponding to the following video frame as a second ratio;
determining an average of the first ratio and the second ratio as the differential result; and
in response that the differential result is less than a preset differential threshold, determining that the transition animation is used.

9. The method according to claim 3, wherein the recognizing, from the scene switching clip, a transition type to which the transition animation belongs, comprises:
dividing the scene switching clip into a preset first number of intervals;
for each interval divided, selecting a target video frame from the interval, acquiring a preset second number of consecutive video frames following the target video frame, and performing a differential operation on the target video frame and the consecutive video frames to obtain differential images; and
inputting the differential images corresponding to the first number of intervals into a pre-trained transition type recognition model, to obtain the transition type to which the transition animation belongs.

10. The method according to claim 3, wherein after the recognizing, from the scene switching clip, a transition type to which the transition animation belongs, the method further comprises:
acquiring an overlap identification corresponding to the transition type, wherein the overlap identification is used for indicating whether the transition animation has an overlap with a slot content; and
in response that the overlap identification indicates that the transition animation has an overlap with the slot content, compensating a duration of the slot content.

11. The method according to claim 1, wherein the material information comprises at least one of: text information, audio information, special effect information, or sticker information.

12. The method according to claim 11, wherein the text information further comprises at least one of: a timestamp interval corresponding to text, a position coordinate corresponding to the text, a text font, or a text font size.

13. (canceled)

14. An electronic device, comprising:
one or more processors; and
a storage device having one or more programs stored thereon,
the one or more programs, when executed by the one or more processors, causing the one or more processors to implement a video template generation method, comprising:
acquiring a video to be analyzed;
on the basis of the video to be analyzed, performing transition detection to obtain target transition information;
on the basis of the video to be analyzed, determining material information; and
on the basis of the target transition information and the material information, generating a video template corresponding to the video to be analyzed.

15. A computer-readable medium, having thereon stored a computer program which, when executed by a processor, implements a video template generation method, comprising:
acquiring a video to be analyzed;
on the basis of the video to be analyzed, performing transition detection to obtain target transition information;
on the basis of the video to be analyzed, determining material information; and
on the basis of the target transition information and the material information, generating a video template corresponding to the video to be analyzed.

16. (canceled)

17. The device according to claim 14, wherein before the acquiring a video to be analyzed, the method further comprises:
in response to receiving a template generation request for a currently browsed video, determining the currently browsed video as the video to be analyzed; and
after the generating a video template corresponding to the video to be analyzed on the basis of the target transition information and the material information, the method further comprises:
generating a video by using the video template.

18. The device according to claim 14, wherein the performing transition detection to obtain target transition information on the basis of the video to be analyzed, comprises:
performing cut-away detection on the video to be analyzed to obtain a cut-away video frame;
on the basis of the cut-away video frame, determining whether a transition animation is used;
in response that determining the transition animation is used, intercepting a scene switching clip from the video to be analyzed; and
recognizing, from the scene switching clip, a transition type to which the transition animation belongs.

19. The device according to claim 18, wherein the performing cut-away detection on the video to be analyzed to obtain a cut-away video frame, comprises:
determining a cut-away probability corresponding to each video frame in the video to be analyzed, to obtain a cut-away probability sequence;
smoothing the cut-away probability sequence; and
on the basis of the smoothed cut-away probability sequence, determining the cut-away video frame from the video to be analyzed.

20. The medium according to claim 15, wherein before the acquiring a video to be analyzed, the method further comprises:
in response to receiving a template generation request for a currently browsed video, determining the currently browsed video as the video to be analyzed; and
after the generating a video template corresponding to the video to be analyzed on the basis of the target transition information and the material information, the method further comprises:
generating a video by using the video template.

21. The medium according to claim 15, wherein the performing transition detection to obtain target transition information on the basis of the video to be analyzed, comprises:
performing cut-away detection on the video to be analyzed to obtain a cut-away video frame;
on the basis of the cut-away video frame, determining whether a transition animation is used;
in response that determining the transition animation is used, intercepting a scene switching clip from the video to be analyzed; and
recognizing, from the scene switching clip, a transition type to which the transition animation belongs.

22. The medium according to claim 21, wherein the performing cut-away detection on the video to be analyzed to obtain a cut-away video frame, comprises:
determining a cut-away probability corresponding to each video frame in the video to be analyzed, to obtain a cut-away probability sequence;
smoothing the cut-away probability sequence; and
on the basis of the smoothed cut-away probability sequence, determining the cut-away video frame from the video to be analyzed.
